(19) United States
(12) Patent Application Publication
(10) Pub. No.: US 2006/0156886 A1
(43) Pub. Date: Jul. 20, 2006

(54) Paper cutter

(76) Inventors: Hideyuki Suzuki, Tokyo (JP); Masayuki Kato, Tokyo (JP)

Correspondence Address: Michael S. Leonard;Everest Intellectual Property Law Group, P.O. Box 708, Northbrook, IL, 60065, US

(21) Appl. No.: 11/334,194

(22) Filed: Jan. 18, 2006

(30) Foreign Application Priority Data
Jan. 19, 2005 (JP) 2005-011916

(51) Int. Cl. B26D 5/10

(52) U.S. Cl. 83/485; 83/614; 83/455

(57) ABSTRACT

A paper cutter capable of cutting a paper with a width of a margin of the paper adjusted arbitrarily, wherein a fixed blade is provided at an end of a paper mounting base, a guide rail is disposed on a rear face side of the fixed blade, a slider is disposed slidably on the guide rail, a rotary blade holder having a rotary circular blade and an arm are attached to a mobile member, the arm disposed striding over the fixed blade, a paper pressing plate pressing portion for pressing a paper pressing plate disposed such that it is capable of approaching/leaving the fixed blade is attached to the arm, and a scale for adjusting the width of the margin to be formed on a periphery of a cutting object paper is formed in the paper pressing plate in parallel to a cutting line.

### BACKGROUND OF THE INVENTION

1. Field of the Invention

The present invention relates to a paper cutter for cutting a cutting object paper mounted on a paper mounting base by sliding a cutting blade along a guide rail.

2. Description of the Related Art

Conventionally, a paper cutter for cutting a cutting object paper mounted on a paper mounting base by sliding a cutting blade along a guide rail has been used. A paper pressing plate for nipping the cutting object paper together with the paper mounting base or the cutting blade just consists of transparent material, translucent material or opaque material. Thus, if a photographic paper is used as the cutting object paper in such a paper cutter, the photographic paper is difficult to be cut accurately with a desired margin left around a photograph.

### SUMMARY OF THE INVENTION

The present invention intends to provide a paper cutter capable of cutting a cutting object paper nipped by a paper pressing plate with a margin of a desired width from a cutting edge despite its simple structure.

To achieve the above-described object, there is provided a paper cutter comprising: a paper pressing plate for nipping a cutting object mounted on a paper mounting base with a pressure; a slider on which a cutting blade is mounted; and a guide rail for guiding the slider slidably, wherein the paper pressing plate is formed of a transparent plate or a translucent plate and a scale comprising a plurality of lines parallel to a cutting line of the cutting blade is formed in the paper pressing plate.

Since according to the invention, the scale parallel to the cutting edge is formed in the paper pressing plate formed of the transparent or translucent material, the width of a margin can be measured easily by seeing the scale. Additionally, a cutting position of the cutting object paper can be adjusted to have a desired margin width.

The scale may be formed in a front face or a rear face of the paper pressing plate and for example, the scale may comprise a plurality of lines parallel to the cutting line by the cutting blade in a longitudinal direction of the paper pressing plate at an interval of several mm as a distance form the cutting line.

According to such a structure, if a photographic paper on which a photograph is developed or printed is used as a cutting object paper, the width of the margin can be adjusted by seeing the scale on the paper pressing plate through the same paper pressing plate. That is, by setting an edge of a photograph along the aforementioned scale line and measuring the length from that set position up to the fixed blade, the width of the margin may be adjusted.

### BRIEF DESCRIPTION OF THE DRAWINGS

FIG. 1 is an entire perspective view of a paper cutter according to a first embodiment.

FIG. 2 is a perspective view of the paper cutter in which a supporting member of one side thereof is omitted.

FIG. 3 is a perspective view of major portions of a slider according to the embodiment.

FIG. 4 is an entire perspective view of a paper cutter according to a second embodiment.

FIG. 5 is a sectional view taken along the line V-V of FIG. 4.

FIG. 6 is a plan view of major portions of FIG. 4.

### DESCRIPTION OF THE PREFERRED EMBODIMENTS

The preferred embodiments of the invention will be described specifically with reference to the accompanying drawings. In the meantime, the present invention is not restricted to embodiments mentioned below but may be modified in various ways.

### First Embodiment

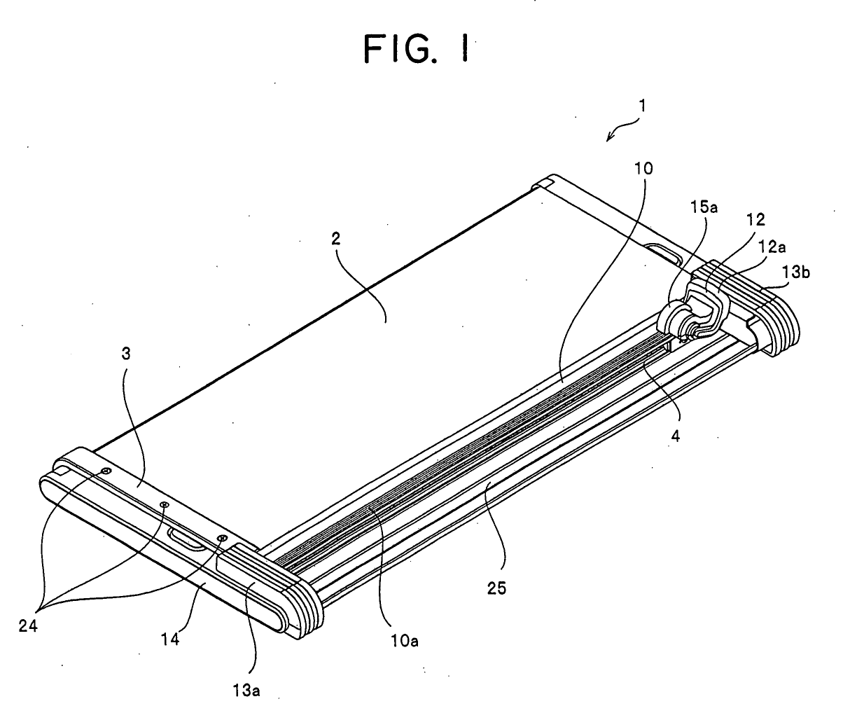

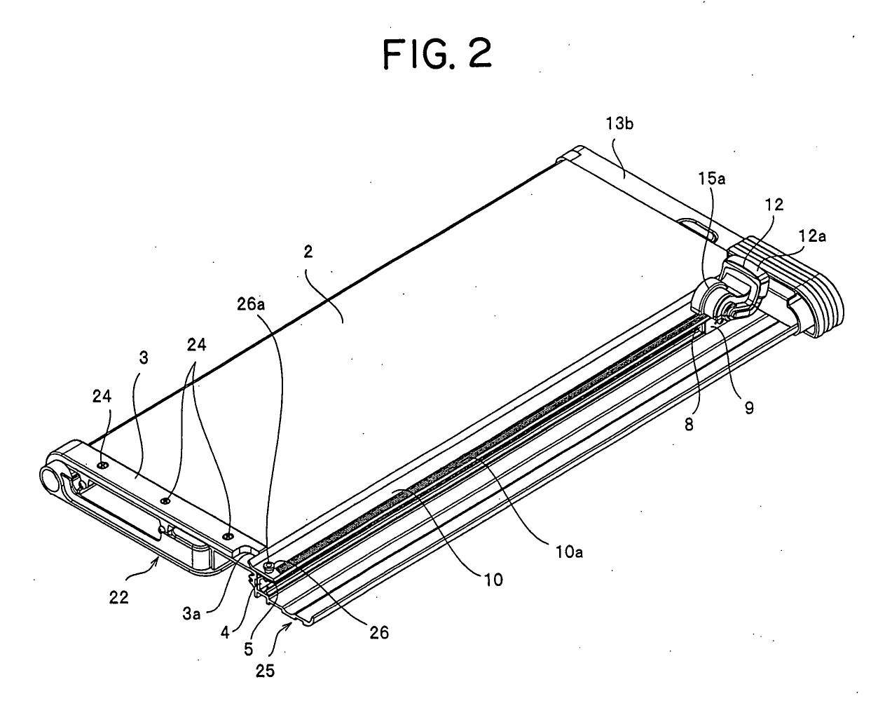

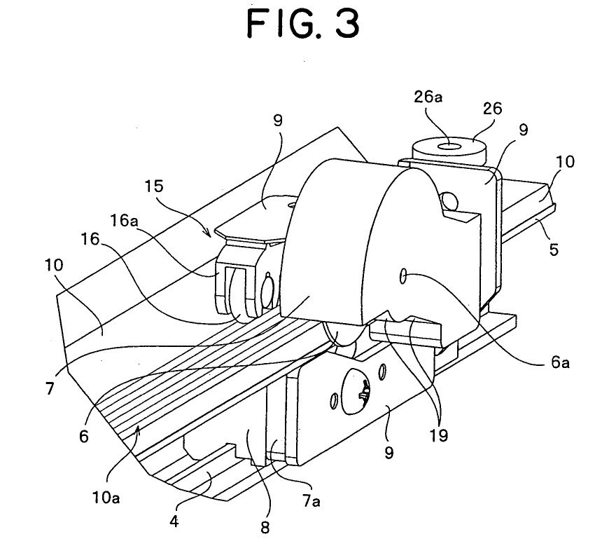

FIG. 1 shows an entire structure of a paper cutter according to one embodiment of the present invention. In the paper cutter 1 shown in FIG. 1, a guide rail is disposed on a rear face of a paper mounting base 2 and the guide rail is not disposed on the paper mounting base 2. Particularly, at an end portion of the paper cutter 1 shown in FIG. 2 whose supporting member 13a is omitted from representation, a long fixed blade 5, whose front face is a substantially the same plane as a top face of the paper mounting base 2 while a guide rail 4 is mounted on a rear face of the fixed blade 5, is provided. A paper pressing plate 10 is disposed on a front face of the fixed blade 5. An elongated hole is formed in a longitudinal direction of the paper pressing plate at each of both end portions of the paper pressing plate 10, and a collar member 26 is loosely fitted to the elongated hole such that it is capable of moving. The paper pressing plate 10 is attached to the paper mounting base 2 via a screw 26a (see FIG. 3) inserted into each collar member 26.

Because the both end portions of the paper pressing plate 10 are loosely fitted via the collar members 26, a gap can be formed between the paper pressing plate 10 and the paper mounting base 2 by pulling up the paper pressing plate 10 in a direction of departing from the paper mounting base 2. As shown in FIGS. 1 and 2, the edge on an opposite side to the fixed blade 5 of the paper pressing plate 10 is formed into an inclined face having an opened insertion mouth so as to guide the cutting object paper mounted on the paper mounting base 2 for easy insertion of the paper.

As shown in FIGS. 1 to 3, the paper pressing plate 10 comprises a transparent plate and a scale 10a parallel to the cutting line of the fixed blade 5, i.e., a cutting edge of the fixed blade is formed on a front face side or a rear face side of the paper pressing plate 10. The width of a margin can be adjusted using the line of the scale 10a through the transparent paper pressing plate 10. The paper pressing plate 10 may comprise not only the transparent plate but also a translucent plate or the like as long as an end or the like of a cutting object paper can be recognized visually through the paper pressing plate 10.

As shown in FIG. 1, supporting members 13a, 13b are disposed on both ends of the paper pressing base 2, and the supporting members constitute a stopper for a paper pressing plate pressing portion 15 or the like sliding along the guide rail 4. The end face of each of the supporting members 13a, 13b is covered with a cover 14. A guide piece 3 for restricting the position of one side of the cutting object paper is fixed to one side edge side of the paper mounting base 2 with screws 24.

As shown in FIG. 2, the fixed blade 5 has a L-shaped section and is fixed to the paper mounting base 2 with screws or the like (not shown) with its L-shaped top face substantially flush with the top face of the paper mounting base 2. On the rear surface side of the fixed blade 5, the substantially U-shaped guide rail 4, which extends parallel to the cutting line of the fixed blade, is fixed by screws or the like (not shown). A dust tray 25 is attached to an end portion of the paper mounting base 2 below the fixed blade 5.

A supporting shaft (not shown) is formed at an end portion of each of the supporting members 13a, 13b disposed on both ends of the paper mounting base 2 and the same supporting shaft acts as a supporting shaft for rotation at an end of an auxiliary paper mounting base 22 disposed on the rear face side of the paper mounting base 2 such that it is capable of being accommodated freely.

As shown in FIG. 3, a mobile member 8 is disposed slidably in a groove of the guide rail 4 and a rotary blade holder 7 and an arm 9 are mounted on this mobile member 8 with screw or the like (not shown). That is, the arm 9 is connected to the mobile member 8 disposed on the rear face side of the fixed blade 5 striding over the fixed blade 5, and independently of the arm 9, the rotary blade holder 7 is connected to the mobile member 8 disposed on the rear face side of the fixed blade 5 striding over the fixed blade 5. In FIGS. 1 and 2, the rotary blade holder 7 is accommodated within a pair of upper and lower covers 15a attached to the arm 9.

As shown in FIG. 3, a rotary circular blade 6 is supported rotatably by a shaft 6a within the rotary blade holder 7. The shaft 6a of the rotary circular blade 6 is disposed above the top face of the fixed blade 5. As a consequence, upon cutting by the rotary circular blade 6, a cutting object paper nipped between the fixed blade 5 and the paper pressing plate 10 can be cut down by the rotary circular blade 6.

The arm 9 is provided with a paper pressing plate pressing portion 15 for pressing the paper pressing plate 10. The paper pressing plate pressing portion 15 is disposed within a pair of upper and lower covers 15a in FIGS. 1 and 2. As shown in FIG. 3, the paper pressing plate pressing portion 15 includes a pressing roller 16, a roller holder 16a supporting the pressing roller 16 rotatably, a leaf spring or the like (not shown) for urging the roller holder 16a toward a side of the paper pressing plate 10. The roller holder 16a is attached to the arm 9 via the leaf spring.

In the paper cutter 1 of the first embodiment, a slider comprises the rotary blade holder 7 sliding together with the mobile body 8, the arm 9, the paper pressing plate pressing portion 15 and the pair of the upper and lower covers 15a.

A pressing position of the paper pressing plate 10 by the pressing roller 16 is set forward in a cutting direction of the rotary circular blade 6 with respect to a cutting position by the rotary blade 6 and the fixed blade 5. As a consequence, cutting of the cutting object paper can be carried out by the rotary blade 6 and the fixed blade 5 with the paper pressing plate 10 pressed forward of the cutting position so as to prevent the cutting object paper from deflecting upon the cutting.

As shown in FIGS. 1 and 2, a grip 12 is formed on the pair of upper and lower covers 15a. Further, a rubber portion 12a is disposed on a peripheral portion of the grip 12 to improve a contact condition with the hand, which presses and operates the grip 12.

By pressing the grip 12, the pair of upper and lower covers 15a may be slid along the guide rail 4. Consequently, the cutting object paper nipped between the fixed blade 5 and the paper pressing plate 10 can be cut by the rotary circular blade 6 and the fixed blade 5. Further, a cut piece may be stored within the dust tray 25.

As shown in FIGS. 1 to 3, a scale 10a comprising a plurality of lines and indicating a distance from the cutting line is formed on the rear face side of the paper pressing plate 10. By adjusting the cutting position of the cutting object paper inserted in between the paper pressing plate 10 and the paper mounting base 2 while watching the scale 10a of the paper pressing plate 10, the cutting object paper can be cut with a desired margin.

Consequently, by setting an edge of a photograph in a photographic paper on the scale 10a formed on the paper pressing plate 10, the width of a margin to be formed around the photograph can be adjusted arbitrarily. That is, by cutting the photographic paper, on which the photograph is printed, at a position apart from the cutting line of the fixed blade 5 by a predetermined distance, the width of the margin around the photograph can be formed corresponding to the predetermined distance from the cutting line of the fixed blade 5.

### Second Embodiment

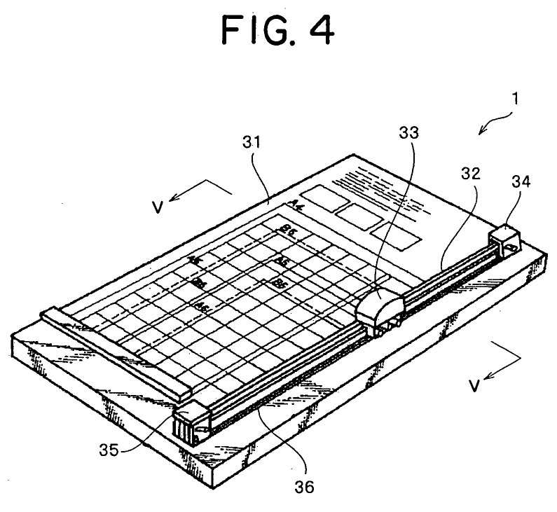

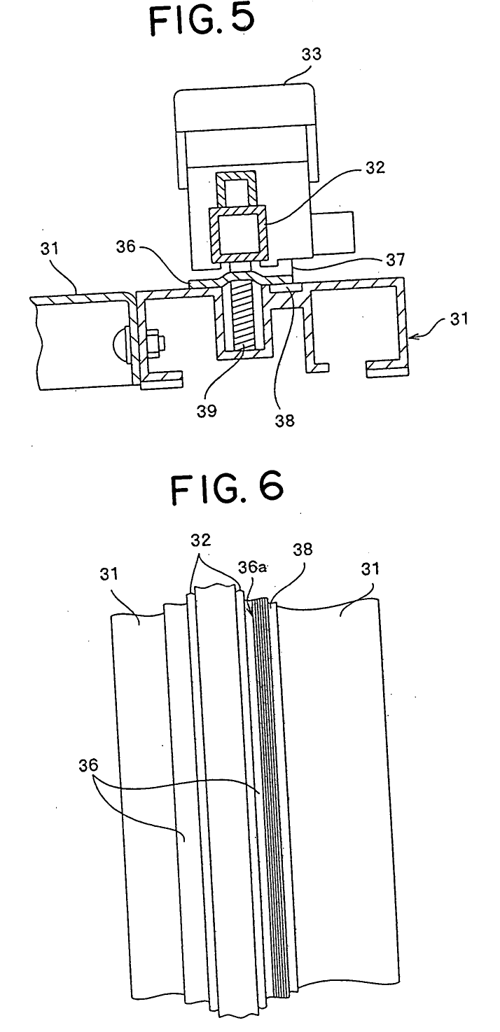

FIG. 4 shows an entire perspective view of the paper cutter 1 of the invention and FIG. 5 shows a sectional view taken along the line V-V of FIG. 4. FIG. 6 shows a partially plan view of the structure of a paper pressing plate 36.

As shown in FIG. 4, a guide rail 32 for sliding and guiding a slider 33 is disposed at a side of an end of a paper mounting base 31. Both ends of the guide rail 32 are provided such that they can be raised or lowered by supporting members 34, 35 fixed on the paper mounting base 31.

The paper pressing plate 36 located below the guide rail 32 is provided such that it can independently be raised or lowered vertically with respect to the paper mounting base 31. A slider 33 is mounted slidably on the guide rail 32.

As shown in FIG. 5, the slider 33 is disposed such that it is slidably fitted to the guide rail 32 and a side face of a rotary circular blade 37 supported rotatably by the slider 33 is kept in contact with a side edge of the paper pressing plate 36. The side edge of the paper pressing plate 36 serves as the cutting line by the rotary circular blade 37. The paper mounting base 31 which the blade of the rotary circular blade 37 comes into contact with is provided with rubber 38 for protecting the tip of the rotary circular blade 37.

As FIG. 6 indicates part of FIG. 4, the paper pressing plate 36 comprises a transparent long plate and a scale 36a is formed of lines drawn in parallel from the cutting line at an interval of several mm in a rear face side of the paper pressing plate 36. The paper pressing plate 36 may comprise a translucent material or the scale 36a may be formed in a front face of the paper pressing plate 36 as long as a portion constituting a margin of the paper can be seen through the paper pressing plate 36.

By pressing the slider 33, as shown in FIGS. 4 and 5, the guide rail 32 may be lowered in parallel to the paper mounting base 31 with guided by the supporting members 34, 35. And at the same time, by lowering the paper pressing plate 36, the cutting object paper can be nipped between the paper pressing plate 36 and the paper mounting base 31.

At this time, if the nipping with respect to the cutting object paper is weakened to some extent and the position of the cutting object paper is adjusted between the paper pressing plate 36 and the paper mounting base 31, the width of the margin to be formed on the cutting object paper can be adjusted with watching the scale 36a. After the position adjustment of the cutting object paper ends, by sliding the slider 33 along the guide rail 32 with the cutting object paper nipped between the paper pressing plate 36 and the paper mounting base 31, the cutting object paper nipped between the paper pressing plate 36 and the paper mounting base 31 can be cut by the rotary circular blade 37 with a predetermined margin.

If pressing of the slider 33 is released, the guide rail 32 is moved upward by a drive mechanism (not shown). At this time, the paper pressing plate 36 is raised vertically with respect to the paper mounting base 31 by a compression spring 39 while guided by a guide member (not shown) until its stopper member (not shown) comes into contact with the guide rail 32. In the paper cutter 1 of the second embodiment, the top face of the paper mounting base 31 and the paper pressing plate 36 are parallelized each other so that a gap is formed therebetween.

Although in the embodiments, an example in which the scale 10a, 36a is formed in the paper pressing plate at an interval of several mm has been described, the scale may be formed of lines at an interval of 1 mm or at an interval of other unit, for example, inch. In addition, the plate of the invention is not limited to a plate for pressing a paper.

The technology of the invention can be applied to an apparatus having the same configuration as the paper cutter.

What is claimed is:

1. A paper cutter comprising: a plate for nipping a cutting object paper mounted on a paper mounting base between the plate and the paper mounting base; a slider on which a cutting blade is mounted; and a guide rail for guiding the slider slidably, wherein
the plate is formed of a transparent plate or a translucent plate and a scale comprising a plurality of lines parallel to a cutting line of the cutting blade is formed in the plate.

2. The paper cutter according to claim 1, wherein the plate is a paper pressing plate for nipping the cutting object paper with a pressure.
